(19) United States
(12) Patent Application Publication
(10) Pub. No.: US 2022/0180264 A1
(43) Pub. Date: Jun. 9, 2022

(54) ENTERPRISE WORKFORCE MANAGEMENT PLATFORM

(71) Applicant: Utmost Software, Inc., Dublin (IE)

(72) Inventors: Paddy Benson, Dublin (IE); Sean Coughlan, Dublin (IE); Noel Winstanley, Dublin (IE)

(73) Assignee: Utmost Software Inc., Dublin (IE)

(21) Appl. No.: 17/116,261

(22) Filed: Dec. 9, 2020

(51) Int. Cl. G06Q 10/06; G06F 16/25

(52) U.S. Cl. CPC G06Q 10/06311; G06F 16/252

(57) ABSTRACT

A platform for allowing large companies, such as enterprise companies, to effectively and automatically manage their workforce. The platform provides a single instance for workers and workforce suppliers to login and provide an access worker data. The platform allows an enterprise entity to access worker and workforce supplier data through a single application associated with the enterprise. An enterprise entity, workforce supplier, and workers may be linked together through a certified engagement. One or more standard or custom forms, tasks, and objects may be generated for each enterprise for use in one or more workflows for the enterprise. A generated workflow can automatically be performed, at least in part by communicating with workflow logic. The workflow logic may receive information requests and/or queries from the enterprise application, and route the requests and/or queries to a particular worker, administrator, or other appropriate destination in order to complete the workflow.

### BACKGROUND

Large companies, often called enterprise companies, employ thousands of workers throughout the globe. These enterprise companies have relationships and requirements for the workers, as well as supplier organizations that provide workers for the enterprise company.

There are several tasks and management processes that need to be performed during a worker's tenure with an enterprise company. Some existing systems attempt to meet this need from a supplier point of view. In particular, an employee supplier company may provide an application that allows an enterprise company to perform limited tasks associated with the workers that the supplier company provides. The supplier company application typically has its own data formatting, and only provides information for the workers that it manages and/or provides for the enterprise company. Enterprise company often works with dozens or more of the supplier companies, resulting in an unwieldy number of applications that must be configured to manage workers associated with each supplier.

What is needed is an improved system for managing an enterprise workforce.

### SUMMARY

The present technology, roughly described, provides a platform for allowing large companies, such as enterprise companies or entities, to effectively and automatically manage their workforce. The present platform provides for a single workforce application for workers and workforce suppliers to login and provide an access worker data. The platform also allows an enterprise entity to access worker and workforce supplier data through a single dedicated enterprise application associated with the particular enterprise.

An enterprise entity, workforce supplier, and workers may be linked together through an engagement. The engagement can include an agreement of employment between the enterprise entity and one or more workers, either directly or through a workforce supplier. For each engagement, the enterprise entity, through the enterprise application, may generate one or more standard or custom forms, tasks, and objects for the engagement. One or more workflows may be generated through the enterprise application, and may utilize one or more of the forms, tasks, and objects created for the enterprise engagement. For example, a workflow may be composed of workflow building blocks. The workflow building blocks may be arranged in a preset order for standard workflows, or in a customized order for custom designed workflows. Each enterprise may generate any number of standard or customized workflows for a particular engagement. Each workflow can be extensible and built using one or more gateway building blocks and one or more decision point building blocks. The workflow building block may include business process model and notation (BPMN) blocks. The building blocks that compose a workflow enable the workflow to perform a transaction on behalf of the enterprise.

In some instances, a method for automatically managing a workforce is performed by the present platform. The method begins with creating a workflow for one of a plurality of entities having an account with an Enterprise application by an Enterprise application, wherein the entity has an engagement with a plurality of workers and suppliers. The created workflow is automatically performed by the Enterprise application for the entity. Automatically performing the workflow can include transmitting one or more information requests to workflow logic of a worker application. The one or more information requests are transmitted by the workflow logic to a subset of less than all the plurality of workers and suppliers. The subset of less than all the plurality of workers and suppliers can be part of the engagement with the enterprise entity. A response is transmitted by the workflow logic in the worker application to the Enterprise application. Results of the information requests are stored to a data store by the Enterprise application.

In some instances, a non-transitory computer readable storage medium has embodied thereon a program. The program is executable by a processor to perform a method for automatically managing a workforce. The method begins with creating a workflow for one of a plurality of entities having an account with an Enterprise application by an Enterprise application, wherein the entity has an engagement with a plurality of workers and suppliers. The created workflow is automatically performed by the Enterprise application for the entity. Automatically performing the workflow can include transmitting one or more information requests to workflow logic of a worker application. The one or more information requests are transmitted by the workflow logic to a subset of less than all the plurality of workers and suppliers. The subset of less than all the plurality of workers and suppliers can be part of the engagement with the enterprise entity. A response is transmitted by the workflow logic in the worker application to the Enterprise application. Results of the information requests are stored to a data store by the Enterprise application.

A system for automatically allocating resource usage to key performance indicators includes a server. The server includes a memory, a processor, and one or more modules, where the one or more modules are stored in memory and executable by the processor. The modules are executable to create a workflow for one of a plurality of entities having an account with an Enterprise application by an Enterprise application, the entity having an engagement with a plurality of workers and suppliers, automatically perform the created workflow by the Enterprise application for the entity, wherein automatically performing the workflow includes transmitting one or more information requests to workflow logic of a worker application, transmit the one or more information requests by the workflow logic to a subset of less than all the plurality of workers and suppliers, the subset of less than all the plurality of workers and suppliers being part of the engagement with the enterprise entity, transmit a response by the workflow logic in the worker application to the Enterprise application, and store results of the information requests to a data store by the Enterprise application.

### BRIEF DESCRIPTION OF FIGURES

FIG. 1 is a block diagram of a work force management platform.

FIG. 2 illustrates a block diagram of a worker application.

FIG. 3 illustrates a block diagram of an Enterprise application.

FIG. 4 illustrates a method for managing a workforce.

FIG. 5 illustrates a method for creating a workflow for an enterprise entity.

FIG. 6 is a method for automatically performing a created workflow.

FIG. 7 illustrates a method for processing and information request by a workflow logic.

FIG. 8 illustrates a method for a worker accessing an account with a worker application.

FIG. 9 illustrates a method for a supplier accessing an account with a worker application.

FIG. 10 illustrates the processing of a request for information using attribute-based access control.

FIG. 11 is a block diagram of a system for implementing machines that implement the present technology.

### DETAILED DESCRIPTION

The present system provides a platform for allowing large companies, such as enterprise companies or entities, to effectively and automatically manage their workforce. The present platform provides for a single workforce application for workers and workforce suppliers to login and provide an access worker data. The platform also allows an enterprise entity to access worker and workforce supplier data through a single dedicated enterprise application associated with the particular enterprise.

An enterprise entity, workforce supplier, and workers may be linked together through an engagement. The engagement can include an agreement of employment between the enterprise entity and one or more workers, either directly or through a workforce supplier. For each engagement, the enterprise entity, through the enterprise application, may generate one or more standard or custom forms, tasks, and objects for the engagement. One or more workflows may be generated through the enterprise application, and may utilize one or more of the forms, tasks, and objects created for the enterprise engagement. For example, a workflow may be composed of workflow building blocks. The workflow building blocks may be arranged in a preset order for standard workflows, or in a customized order for custom designed workflows. Each enterprise may generate any number of standard or customized workflows for a particular engagement. Each workflow can be extensible and built using one or more gateway building blocks and one or more decision point building blocks. The workflow building block may include business process model and notation (BPMN) blocks. The building blocks that compose a workflow enable the workflow to perform a transaction on behalf of the enterprise.

Once a workflow is generated, it can automatically be performed, at least in part by communicating with workflow logic associated with an application that manages worker data and other information. The workflow logic may receive information requests and/or queries from the enterprise application, and route the requests and/or queries to a particular worker, administrator, or other appropriate destination in order to complete the workflow. For example, the workflow logic may receive a request from an enterprise application to provide a query or document to a particular role for a suppler entity (which accesses the worker application). The workflow logic receives a request from the enterprise application, which is initiated by the workflow building blocks. The workflow logic then automatically determines how and where to route the particular query or document. The workflow logic can process requests and instructions from an enterprise application even when the recipient of a request or document is not known by the enterprise application. In some instances, the workflow logic may use one or more parameters such as recipient role, recipient security clearance and access permissions, recipient resource permissions, and other parameters. For example, an enterprise application may want to transmit a document to a particular person at a supplier, such as a person having a particular role at the supplier and having access to time sheet information that is owned by the enterprise. Based on the specified role, resource access, and relationship of the resource to the enterprise, the workflow logic can determine the correct recipient of the document at the supplier even through the actual identify of the recipient is not known to the enterprise application which transmits the document.

The platform of the present technology inherently has several novel features. For example, the platform provides for a single login and system (worker application) for all workers and suppliers to access the platform while providing each enterprise entity with a dedicated instance or enterprise application. The worker application can be used by all workers to login to their account, provide and update their data, perform workflow tasks as required or requested by enterprise entities and worker supplier entities, and perform other tasks and operations. In some instances, the worker application can be hosted by a web service provider. Since each enterprise entity can create custom workflows for a particular engagement, a worker may experience a first workflow with a first enterprise entity and application and a different workflow with a second enterprise entity for the same type of transaction, such as execution of an employment agreement. Regardless of the differences in enterprise workflows, however, each worker will perform workflow tasks, access workflow documents, and otherwise handle employment workflow requirements through a single login and account, regardless of the number of enterprise entities (e.g., employers) with which they have engagements. A permission system may provide fine-grain access to data based on roles, permissions, and relationships between a requestor and requestee or resource. The permissions system is implemented at least in part with a massive graph of data representing the entire enterprise that is being accessed by a request. A request may specify each piece of data that is being sought. For example, a request may specifically request person's name, address, phone number, and social security number. Each field in the request may be granted or denied. As a result, access can be determined to record fields rather than limited to a record as a whole. Access can be granted based on an assigned permission and/or role as well as a relationship. For example, a supervisor within an enterprise that requests a contractor name and address may not be granted access to the requested information based on the supervisor's role alone. However, if the contractor works for the department in which the supervisor works, that department relationship—same department—may allow the supervisor to access the requested information.

The present technology addresses a technical problem associated with inefficiently managing enterprise entity workforce transactions. Currently, workforce suppliers provide their own applications for accessing worker data and having workers perform tasks. Each workforce supplier application has its own data formats, APIs, role descriptions, permissions scheme, and other unique attributes. When an enterprise entity wants to manage a workflow using computer resources, the notion of managing connections to dozens or hundreds of workforce supplier applications is impractical if not impossible. In particular, the computerized resources required to access and update data from all the workforce supplier applications would be extremely expensive in terms of computer processing bandwidth and memory.

The present technology solves the technical problem associated with inefficient workforce management by providing a novel workforce management platform. The platform allows workers and workforce suppliers to login from a single-entry point, such as a webpage, in order to access all the enterprise entities that each worker or workforce supplier is engaged with. By providing a single platform that can be used by all workers, suppliers, and entities engaged with the workers and suppliers, the processing bandwidth and memory to implement the workforce management is much lower, resulting in a much more efficient technical solution to enterprise entity workforce management.

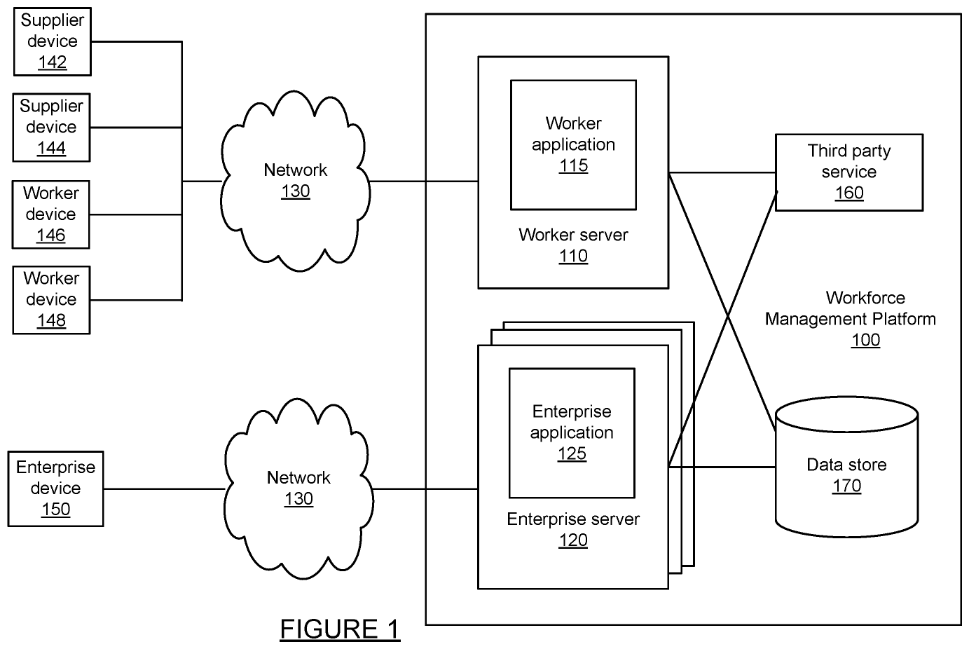

FIG. 1 is a block diagram of a work force management platform 100. FIG. 1 includes worker server 110, enterprise server 120, network 130, workforce supplier devices 142 and 144, worker devices 146 and 148, enterprise device 150, third-party service 160, and data store 170.

Workforce supply entities, companies that provide workers including contractors, part time employees, and full-time employees to enterprise companies, may log into worker server 110 through workforce supplier devices 142 and 144. Workers, including contractors, part time employees, and full-time employees, may log into worker server 110 through worker devices 146 and 148. Each of devices 142-148 may include any sort of computing device that is able to render a network browser application, such as an Internet browser application. The devices 142-148 may communicate with the worker server 110 of platform 100 over network 130.

Members of an enterprise entity workforce (e.g., enterprise company employees) may access enterprise server 120 and enterprise application 125 via one or more devices 150. In some instances, the device 150 may communicate with enterprise application 125 using GraphQL. Enterprise device 150 may include one or more devices or servers associated with an enterprise company that is used to access enterprise server 120. Device 150 may include any computing device that is able to render a network browser application, such as an Internet browser application, that can communicate with Enterprise server 120 over network 130. Network 130 may include one or more private networks, public networks, intranets, the Internet, an intranet, wide-area networks, local area networks, cellular networks, radio-frequency networks, Wi-Fi networks, any other network which may be used to transmit data between computing devices such as the devices, servers, services and data stores illustrated in FIG. 1, and any combination of these networks.

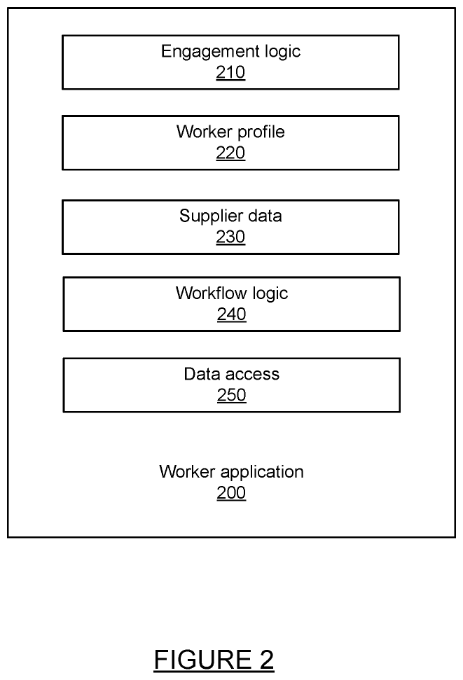

Worker server 110 may include worker application 160. Supply work application 160 may include logic for implementing engagements, worker profile data, supplier data, and logic for one or more workflows associated with an enterprise. A single worker server may be implemented to allow all workers and worker suppliers to access their respective data, perform duties and tasks as part of a workflow, and other functionality as described herein. Worker application 115 is described in more detail with respect to FIG. 2.

Enterprise server 120 includes an enterprise application 125. Enterprise application may include task, workflow data, forms, objects, and other modules for performing functionality discussed herein. In some instances, there may be one enterprise server instance for each enterprise entity that utilizes platform 100. The enterprise application for each enterprise server may include custom objects and workflows specific to a particular engagement. More detail for Enterprise application 125 is discussed with respect to FIG. 23.

Each of supply worker server 110 and enterprise server 120 may communicate with a third-party service 160 and data store 170. A third-party service 160 may include one or more remote third-party services that may allow for data integration with the current platform. Data store 170 may include one or more remote Web services for storing data and/or logic, such as for example worker data, worker supplier data, enterprise data, and other data.

FIG. 2 illustrates a block diagram of a worker application. Worker application 200 of FIG. 2 provides more detail for worker application 115 of the system of FIG. 1. Worker application 200 includes engagement logic 210, worker profile 220, supplier data 230, workflow logic 240, and data access module 250. Engagement logic 210 manages and certifies engagements between an enterprise entity, one or more workers, and one or more workforce suppliers. Engagement logic may store documents related to the engagement and identify the parties subject to a particular engagement.

Worker profile 220 may include profile data for a worker, such as a worker's cell phone, email address, mailing address, and other data associated with a worker.

Supplier data 230 may include data associated with a workforce supplier, such as a supplier name, contact information, types of workers, rates, locations of workers, and other data.

Workflow logic 240 may include circuitry, software, and other components to generate and carry out workflows tasks, information requests, queries, and other workflow elements. The workflow logic 240 may receive information requests or queries from an Enterprise server and carry out the task with a particular worker or workforce supplier, business partner, or some other object or entity. Workflow logic may receive requests from different enterprise applications, for example a request initiated by an enterprise workflow building block, and carry out the request. The inherent logic may process the request to route a request or payload document to an individual or resource that is described in the enterprise workflow request but not completely identified. In some instances, at least a portion of workflow logic 240 may be distributed between a worker application and an enterprise application.

Data access 250 may include one or more modules for accessing data integrations provided by third-party service providers, accessing data stores, and other communications with other physical or logical servers or applications.

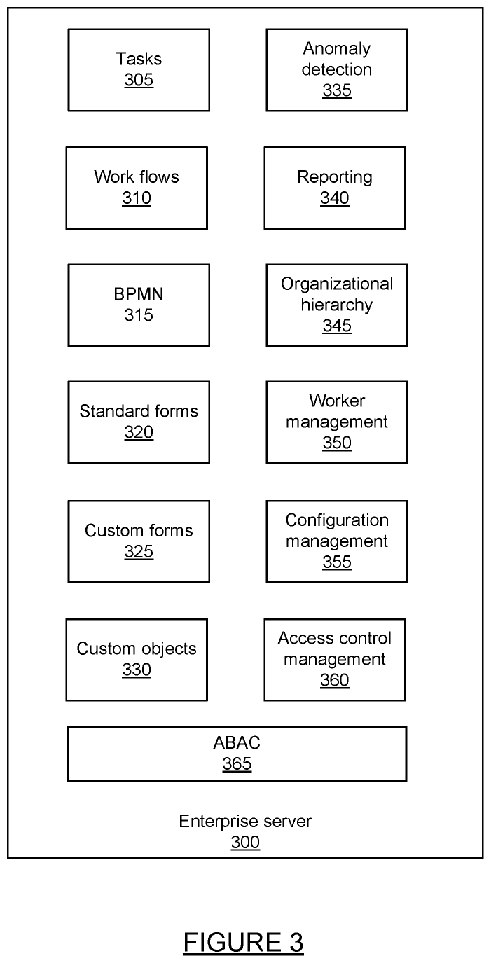

FIG. 3 illustrates a block diagram of an enterprise application. Enterprise application 300 of FIG. 3 provides more detail for Enterprise application 125 in the system of FIG. 1. Enterprise application includes tasks 305, workflows 310, BPMN 315, standard forms 320, custom forms 325, and custom objects 330. The application 300 also includes modules such as an anomaly detection module 335, reporting module 340, organizational hierarchy 345, worker management module 350, configuration management 355, access control management 360, and attribute-based access control module 365. In some instances, more or fewer modules may be implemented to implement the technology and functionality described herein other than modules 305 to 365 as illustrated in FIG. 3.

Tasks module 305 may include standard and customized tasks generated and implemented within a workflow configured by an enterprise entity. Workflows 310 may include one or more processes for performing a transaction, such as for example an employee onboard transaction, associated with an enterprise entity. Workflows may be comprised of one or more workflow building blocks, for example one or more gateways and decision points in a BPMN workflow. Workflows may be generated by an enterprise associated with an instance of an enterprise application, and used in conjunction one or more engagements for the enterprise

BPMN 315 may include a business process modeling notation tool for modeling business processes for a user interface. Standard forms 320 may include one or more forms that are standard (e.g., from a template) and commonly used for enterprise entities. Custom forms 325 may include one or more forms that are customized, either from scratch or from standard forms 320, for an enterprise entity. Custom objects 330 may include one or more objects that are generated in response to user input to implement one or more workflows for an entity.

Anomaly detection 335 may process data to determine an anomaly or risk associated with a worker or workforce supplier. Reporting 340 may report data to an administrator or other individual, for example through one or more dashboards. Organizational hierarchy 345 may construct a hierarchy of an enterprise that includes the workers and workforce suppliers to provide workers, and includes relationships between groups and individuals of the enterprise and workers. Worker management 350 manages the workers employed by an enterprise entity. Configuration management 355 may configure workforce elements such as an engagement, workflows, user accounts, and other aspects of managing a workforce. Access control management may implement access control permissions is generated and determined by the ABAC 365.

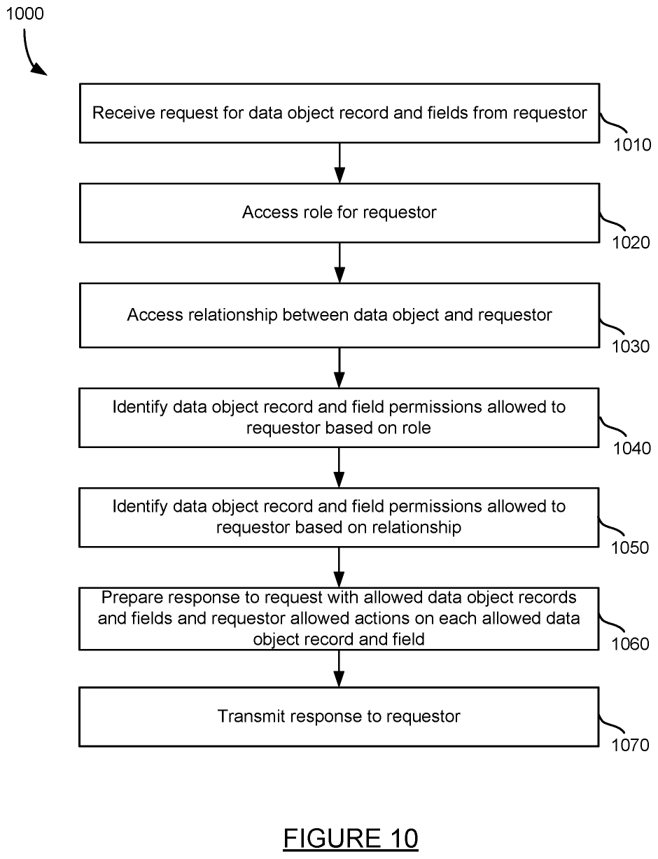

Attribute-based access control (ABAC) 365 may determine access for data requests based on attributes of the requester and the object being requested. For example, access to an object may be granted based at least in part on a roll or attribute of the requester as well as a relationship between the requester and the subject associated with the data. ABAC 365 may provide access to individual fields indicated within a request, providing a fine grain level of access control. For data that is provided to a requester in response to an access request, indications of the requester data permission are provided, such as the permission to add, delete, edit, or create data. This is discussed in more detail herein, for example with respect to the method of FIG. 10.

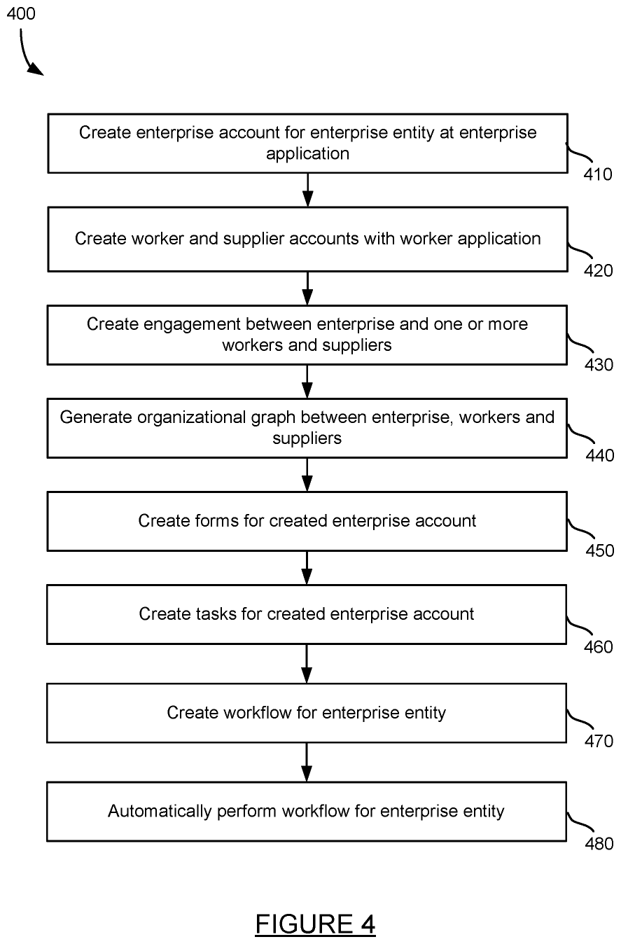

FIG. 4 illustrates a method for managing a workforce. First, an enterprise account is created with an Enterprise application for an entity. In some instances, an enterprise account can be created for a plurality of enterprise companies on the platform of the present technology. Each enterprise account may be associated with an instance of an entity application. Each entity application is associated with a single entity company.

Worker and supplier accounts may be created with a worker application at step 420. Each worker and supplier account are created through the same worker application. A worker and supplier entity may access the worker application through the same interface, for example an interface provided through a web page rendered by a network browser. In some instances, the worker account or supplier account may be generated by a worker or workforce supplier through a mobile application or other software.

An engagement between an enterprise and one or more workers or suppliers may be created at step 430. The engagement may be created, digitally signed by representatives or the actual parties, and may be stored on the platform. The engagement can specify the working relationship between the parties to the engagement. For example, an engagement may specify that an enterprise company is hiring 100 contractors and twenty full time employees, some of which are associated with a workforce supplier and some of which are not. In some instances, links are made between an enterprise, worker, and workforce supplier associated with the particular engagement to which they belong.

An organizational graph may be generated between the enterprise, workers, and suppliers of the engagement at step 440. The organizational graph may indicate relationships between different aspects of the enterprise, workers, and workforce suppliers. For example, the organizational graph, or global worker graph, may indicate the relationships between workers in the enterprise company and contractors or other workers that have an account with the worker application. The organizational graph may also specify information such as geographical location, role, permission, job title, job duration, supervisor, and other parameters for each and every worker that is party to an engagement. The organizational graph may be created in part from data already associated with and stored for a worker at a worker application or server, from data obtained in response to carrying out a workflow, and from data already associated with and stored for a worker at an enterprise application or server.

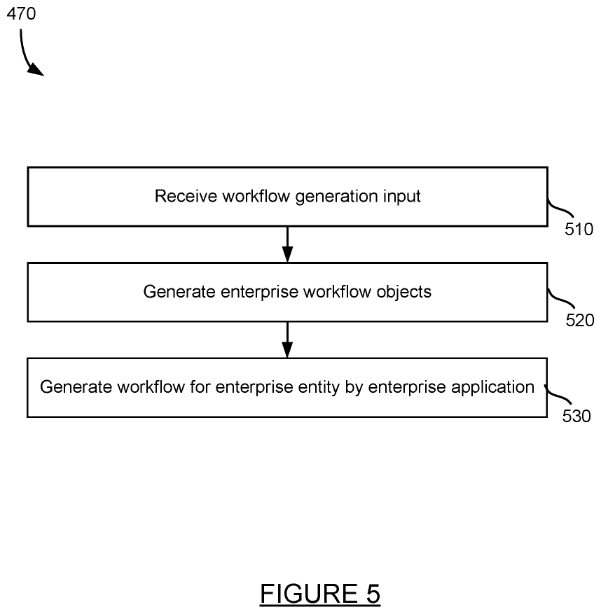

Forms are created for the new enterprise account at step 450. The forms may be standard forms or customized forms generated from the standard forms or from scratch. Tasks may then be created for the enterprise account at step 460. A workflow for the enterprise entity is then created at step 470. Creating a workflow may include receiving workflow generation input and generating a workflow in response to the input. Creating a workflow is discussed in more detail with respect to the method of FIG. 5.

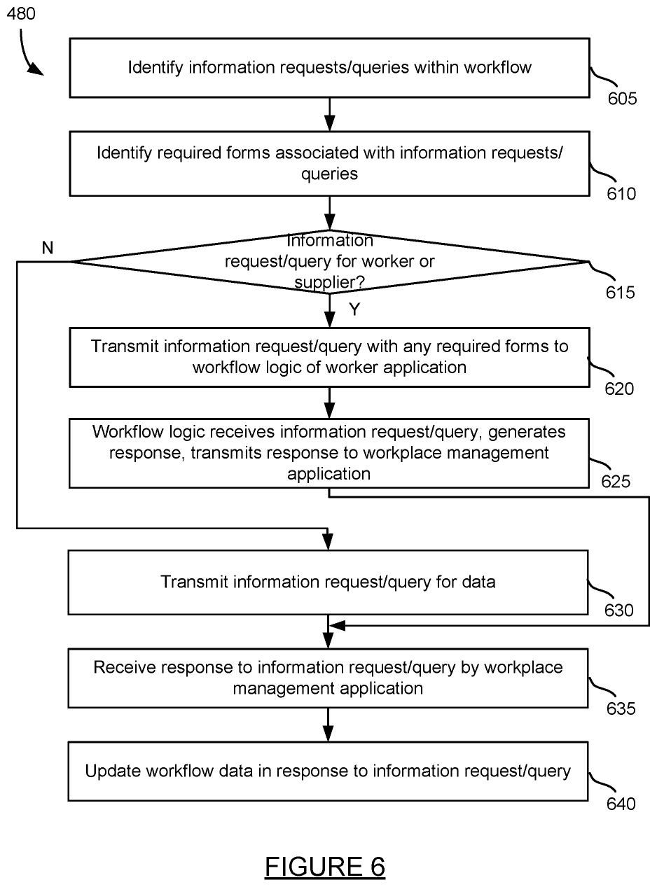

A workflow is automatically performed for an enterprise entity at step 480. Automatically performing a workflow may include identifying information requests, transmitting the requests, executing the request by workflow logic, and updating data based on a response received to the requests. Automatically performing a workflow for an enterprise entity is discussed with more detail with respect to the method of FIG. 6.

FIG. 5 illustrates a method for creating a workflow for an enterprise entity. The method of FIG. 5 provides more detail for step 470 of the method of FIG. 4. First, workflow generation input is received at step 510. The input may be received through a network browser by an administrator or other user associated with the enterprise entity. In some instances, the business process modeling notation tool 315 can be used to generate workflow objects based on received workflow input.

Enterprise workflow objects are generated at step 520. Workflow objects may include a series of data confirmations or requests as specified by the enterprise work process. The workflow objects may be comprised of workflow building blocks. In some instances, the workflow building blocks may include gateways and decision points in a BPMN workflow. A workflow for an enterprise entity may be generated from the workflow objects by the work force management application at step 530. The workflow may be generated by associating the selected workflow building blocks into a workflow object. A workflow object may be customized for a particular enterprise, for example by specifying whom a request should be sent to, what document should be sent to a particular role at a partner company, and other customizations. Each workflow is extensible, and workflows may be generated for normal and custom business processes. The workflow object is then stored and can be executed upon detection of an event, such detecting a new employee account.

FIG. 6 is a method for automatically performing a created workflow. The method of FIG. 6 provides more detail for step 480 of the method of FIG. 4. First, a workflow is initiated and workflow building blocks are executed. As the building blocks are executed, information requests are identified within a workflow at step 605. The information requests, or queries, collectively referred to as information requests, may request data from a worker such as a worker's address, or phone number, or some other data. In some instances, information requests may simply be a request for data.

Required forms associated with the information request are identified at step 610. In some instances, a request may involve a worker filling out a standard or customized form. As such, an appropriate form is accessed by the logic that is executing the workflow at the enterprise application.

A determination is made as whether the information request is intended for a worker or supplier at step 615. If the information request is not intended for a worker or workforce supplier, the method continues to step 630. If the information request is intended for a worker or supplier, the information request is transmitted with any required forms or other resources to a worker application at step 620. The information request may be sent using graphQL to a worker application. The worker application may provide the received request to workflow logic for routing and handling of the request.

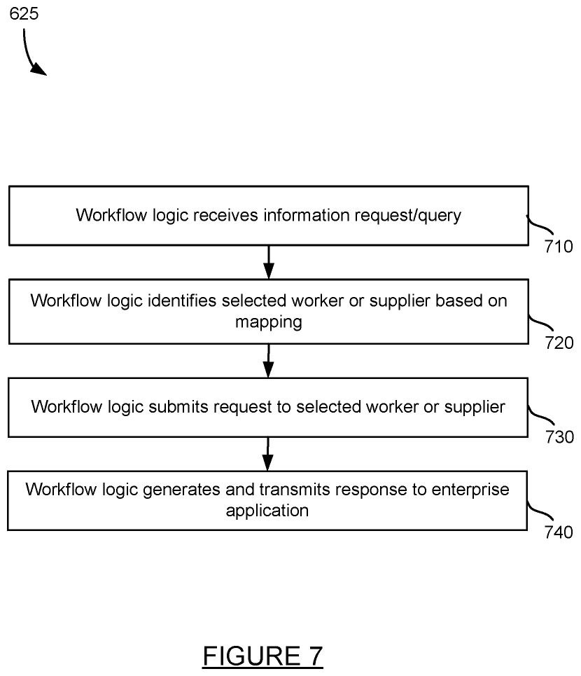

The workflow logic receives the information request from an enterprise application, routes and processes the request, generates a response, and transmits the response to the enterprise application at step 625 More detail for step 625 is discussed with respect to the method of FIG. 7. After transmitting the response to an enterprise application, the method continues to step 635.

An information request for data is transmitted, for example to a third-party service, at step 630. The information request for data may be a request for a third-party service, a request for data from a data store, or some other data request. A response is received to the information request by a workplace management application at step 635. Response may be in response to a request for worker or supplier information or data. Workflow data is an updated in response to the information requests at step 640.

FIG. 7 illustrates a method for processing an information request by a workflow logic. The method of FIG. 7 provides more detail for step 625 of the method of FIG. 6. Workflow logic of a worker application receives an information request at step 710. Workflow logic identifies the selected worker or supplier based on mapping at step 720. In some instances, the mapping may be between a first role defined in the information request by the enterprise entity and a second role associated with the selected worker or supplier. For example, a workflow may generate a request to transmit a document to a particular person at a supplier, such as a person having a particular role at the supplier and having access to tax information that is owned by the enterprise entity. Based on the specified role, resource access, and relationship of the resource to the enterprise, the workflow logic can determine the correct recipient of the document at the supplier even through the actual identify of the recipient is not known to the enterprise application which transmits the document. The mapping can be performed based on a mapping table that is maintained by a worker application or workflow logic that parses the request received by the enterprise application and performs one or more operations based on the parsing, such as provide a document to a particular worker that matches the parameters detected in the request.

Workflow logic may submit the request to the selected worker or supplier based on the mapping at step 730. The selected worker supplier may be one that has an account with the worker application. The workflow logic receives a response from the worker or resource which the request was routed to. The workflow logic then generates and transmit a response to the workplace management application based on the response from the worker or resource at step 740.

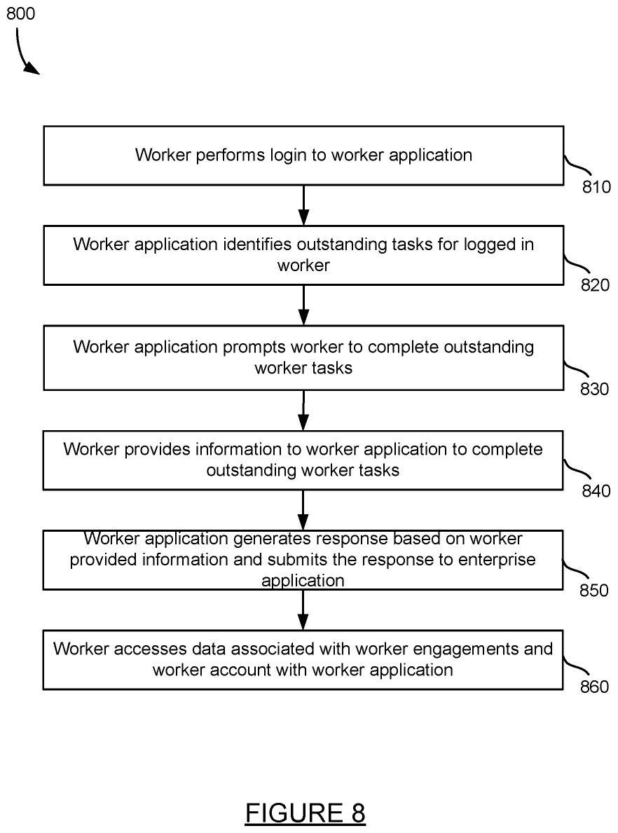

FIG. 8 illustrates a method for a worker accessing an account with a worker application. First, a worker may login to the worker application at step a 10. The worker application may then identify outstanding tasks for the logged in worker at step a 20. The outstanding tasks may be associated with workflows generated by an enterprise entity having an engagement with the logged in worker. Worker application may then prompt the worker to complete any outstanding worker tasks identified at step 830. The worker may provide information to the worker application to complete any outstanding worker tasks at step 840. The worker application and generates a response based on the worker provided information and submits the response to the enterprise application at step 850. In some instances, the worker application may generate a response based on a lack of worker provided information, such as an incomplete entry or no entry received from a worker.

At any time during login, a worker may access data associated with the workers engagements, the workers account, and other worker data at step 860. The worker may access data maintained by the worker application, including data that the worker has entered into the application his or herself.

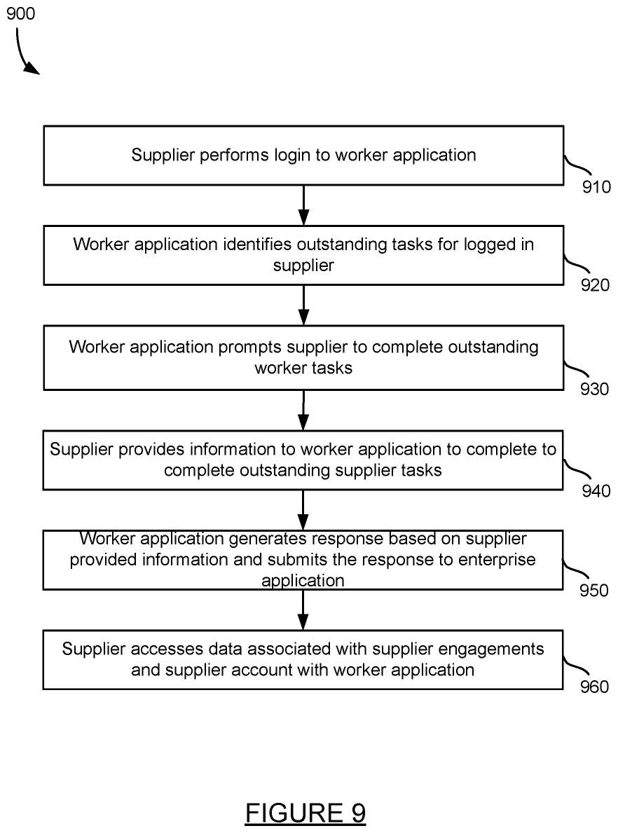

FIG. 9 illustrates a method for a supplier accessing an account with a worker application. First, a supplier may perform login to the worker application at step 810. The worker application may then identify outstanding tasks for the logged in supplier at step a 20. The outstanding tasks may be associated with workflows generated by an enterprise entity having an engagement with the logged in workforce supplier. The worker application may then prompt the supplier to complete any outstanding worker tasks identified at step 930. The supplier may provide information to the worker application to complete any outstanding supplier tasks at step 940. The worker application then generates a response based on the supplier provided information and submits the response to the enterprise application at step 950. In some instances, a worker application may generate a response based on a lack of supplier provided information, such as an incomplete entry or no entry received from a worker.

At any time during login, a supplier may access data associated with the workforce supplier engagements, the supplier account, and other supplier data at step 960. The supplier may access data maintained by the worker application, including data that the worker has entered into the application his or herself.

In some instances, workflows involve requests by a requestor (enterprise employee) for worker data access or resource access. FIG. 10 illustrates the processing of a request for information using attribute-based access control. First, a request for a data object record having one or more fields is received from a requester at step 1010. The request can specify portions of data, for example specific record fields, that the requestor is requesting access to. For example, a request may identify a worker name, worker address, and worker phone number to access.

A role for the requester is accessed at step 1020. The role may be retrieved from the organizational hierarchy module within the enterprise application. The relationship between the data object and the requester may be accessed at step 1030. The relationship may also be accessed from an organizational hierarchy module, which has access to a global worker graph for the enterprise. For example the relationship between the requestor and the request subject or requestee (e.g., a person having data being requested or a resource) may be that they work in the same department, work in different departments, work in the same geographic area, work in the same business unit, or some other relationship.

The data object record and field permissions are identified which are allowed to be provided to the requester based on the requester's role at step 1040. In some instances, permission and access to data is provided in a fine-grain basis, for example down to a record field level. In some instances, a response to a workflow generated information request is in JSON format, which provides for section in each node of a tree which indicates, for each requested filed, the recipient permission for that field (e.g., permission to edit, add, etc.). Hence, if three fields within a record were requested by a requestor, it may be possible that the requestor is only provided access to two of the three requested fields.

The access may be provided based on the requestor role, permissions associated with the data or resource, and the relationship between the requestor and requestee.

Similarly, data object records and fields permissions which are allowed to be provided to the requester based on the relationship are identified at step 1050. The response to the request is prepared based on the access granted to the requestor. In some instances, a response includes data object records and fields and requester allowed actions on each allowed data object record and field. Hence, for each field requested by the requester, fields allowed to be accessed by the requester are provided in response. In addition to the field data, allowed actions that the requester can perform on the fields are provided within the response as well. The response is transmitted to the requester at step 1070.

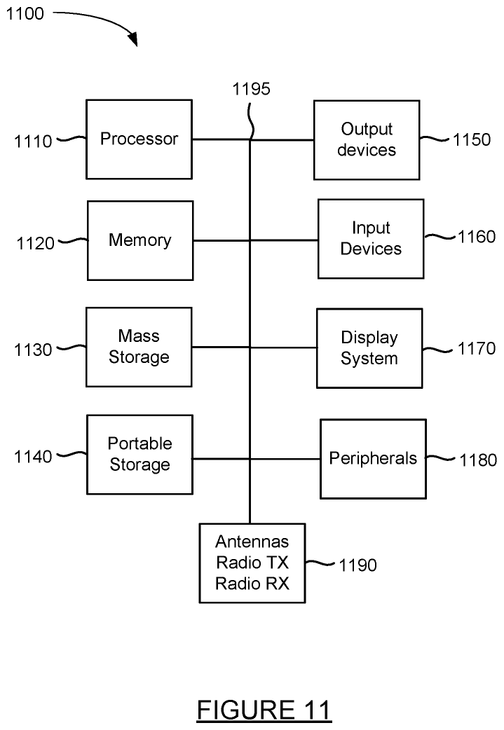

FIG. 11 is a block diagram of a system for implementing machines that implement the present technology. System 1100 of FIG. 11 may be implemented in the contexts of the likes of machines that implement server 110, sever 120, devices 142, 144, 146, 148, and 150, third party service 160, and data store 170. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touchscreen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically managing a workforce, comprising:
creating a workflow for one of a plurality of entities having an account with an Enterprise application by an Enterprise application, the entity having an engagement with a plurality of workers and suppliers;
automatically performing the created workflow by the Enterprise application for the entity, wherein automatically performing the workflow includes transmitting one or more information requests to workflow logic of a worker application;
transmitting the one or more information requests by the workflow logic to a subset of less than all the plurality of workers and suppliers, the subset of less than all the plurality of workers and suppliers being part of the engagement with the enterprise entity;
transmitting a response by the workflow logic in the worker application to the Enterprise application; and
storing results of the information requests to a data store by the Enterprise application.

2. The method of claim 1, wherein the worker application maintains an account for each of a plurality of workers and suppliers

3. The method of claim 1, wherein the entity is an enterprise entity

4. The method of claim 1, the engagement including an agreement to hire the subset of workers and suppliers by the entity

5. The method of claim 1, wherein one of the plurality of workers and suppliers has an engagement with two or more entities, the one of the plurality of workers and suppliers having a single account with the worker application to access information request from the two or more entities.

6. The method of claim 1, further comprising:
receiving a request for worker or supplier data by the worker application;
identifying the role of the requestor and the relationship between the requestor and the worker or supplier for which data is selected; and
providing a response to the request, the response including portions of the requested data to the requestor based on the role and relationship.

7. The method of claim 1, further comprising
determining the requestor permission type for each portion of the requested data; and
Including the requestor permission type for each portion of the requested data.

8. The method of claim 1, wherein the suppler-worker application workflow logic includes a mapping between a first role identified by the Enterprise application and a second role identified by a third party, the workflow logic routing at least one of the one or more information requests based on the mapping.

9. The method of claim 1, wherein the created workflow is generated from one or more customized objects generated for the entity within the Enterprise application.

10. A non-transitory computer readable storage medium having embodied thereon a program, the program being executable by a processor to perform a method for automatically managing a workforce, the method comprising:
creating a workflow for one of a plurality of entities having an account with an Enterprise application by an Enterprise application, the entity having an engagement with a plurality of workers and suppliers;
automatically performing the created workflow by the Enterprise application for the entity, wherein automatically performing the workflow includes transmitting one or more information requests to workflow logic of a worker application;
transmitting the one or more information requests by the workflow logic to a subset of less than all the plurality of workers and suppliers, the subset of less than all the plurality of workers and suppliers being part of the engagement with the enterprise entity;
transmitting a response by the workflow logic in the worker application to the Enterprise application; and
storing results of the information requests to a data store by the Enterprise application.

11. The non-transitory computer readable storage medium of claim 10, wherein the worker application maintains an account for each of a plurality of workers and suppliers

12. The non-transitory computer readable storage medium of claim 10, wherein the entity is an enterprise entity

13. The non-transitory computer readable storage medium of claim 10, the engagement including an agreement to hire the subset of workers and suppliers by the entity

14. The non-transitory computer readable storage medium of claim 10, wherein one of the plurality of workers and suppliers has an engagement with two or more entities, the one of the plurality of workers and suppliers having a single account with the worker application to access information request from the two or more entities.

15. The non-transitory computer readable storage medium of claim 10, the method further comprising:
receiving a request for worker or supplier data by the worker application;
identifying the role of the requestor and the relationship between the requestor and the worker or supplier for which data is selected; and
providing a response to the request, the response including portions of the requested data to the requestor based on the role and relationship.

16. The non-transitory computer readable storage medium of claim 10, the method further comprising
determining the requestor permission type for each portion of the requested data; and
Including the requestor permission type for each portion of the requested data.

17. The non-transitory computer readable storage medium of claim 10, wherein the suppler-worker application workflow logic includes a mapping between a first role identified by the Enterprise application and a second role identified by a third party, the workflow logic routing at least one of the one or more information requests based on the mapping.

18. The non-transitory computer readable storage medium of claim 10, wherein the created workflow is generated from one or more customized objects generated for the entity within the Enterprise application.

19. A system for automatically managing a workforce, comprising:
a server including a memory and a processor; and
one or more modules stored in the memory and executed by the processor to create a workflow for one of a plurality of entities having an account with an Enterprise application by an Enterprise application, the entity having an engagement with a plurality of workers and suppliers, automatically perform the created workflow by the Enterprise application for the entity, wherein automatically performing the workflow includes transmitting one or more information requests to workflow logic of a worker application, transmit the one or more information requests by the workflow logic to a subset of less than all the plurality of workers and suppliers, the subset of less than all the plurality of workers and suppliers being part of the engagement with the enterprise entity, transmit a response by the workflow logic in the worker application to the Enterprise application, and store results of the information requests to a data store by the Enterprise application.

20. The system of claim 17, wherein one of the plurality of workers and suppliers has an engagement with two or more entities, the one of the plurality of workers and suppliers having a single account with the worker application to access information request from the two or more entities.
